(19) United States
(12) Patent Application Publication
(10) Pub. No.: US 2013/0251375 A1
(43) Pub. Date: Sep. 26, 2013

(54) RECEIVER, TRANSMITTER AND COMMUNICATION SYSTEM

(71) Applicants: Nau Ozaki, Kawasaki-Shi (JP); Jun Deguchi, Kawasaki-Shi (JP); Hideaki Majima, Tokyo (JP); Toshiyuki Yamagishi, Tokyo (JP)

(72) Inventors: Nau Ozaki, Kawasaki-Shi (JP); Jun Deguchi, Kawasaki-Shi (JP); Hideaki Majima, Tokyo (JP); Toshiyuki Yamagishi, Tokyo (JP)

(73) Assignee: KABUSHIKI KAISHA TOSHIBA, Tokyo (JP)

(21) Appl. No.: 13/601,526

(22) Filed: Aug. 31, 2012

(30) Foreign Application Priority Data
Mar. 23, 2012 (JP) 2012-067765

(51) Int. Cl. H04B 10/10

(52) U.S. Cl. 398/130; 398/118

(57) ABSTRACT

According to one embodiment, a receiver includes an image sensor, a synchronization controller, and a data generator. The image sensor detects a visible ray having a lattice-shaped emission pattern. The synchronization controller determines whether it is necessary to generate data based on a first synchronized visible ray located at a first lattice corner of the emission pattern and a second synchronized visible ray located at a second lattice corner. The second lattice corner is an opposite corner to the first lattice corner. The data generator generates the data corresponding to a data visible ray located at a lattice point other than the first lattice corner and the second lattice corner when the synchronization controller determines that it is necessary to generate the data.

### CROSS REFERENCE TO RELATED APPLICATION(S)

This application is based upon and claims the benefit of priority from the prior Japanese Patent Application No. 2012-067765, filed on Mar. 23, 2012, the entire contents of which are incorporated herein by reference.

### FIELD

Embodiments described herein relate generally to a receiver, a transmitter, and a communication system.

### BACKGROUND

Nowadays there is well known a communication system in which data communication is conducted using a light signal. Generally, the communication system includes a receiver and a transmitter. Plural light sources disposed into a lattice shape are provided in the transmitter. Based on a string of data bits transmitted to the receiver, the transmitter determines the light source to be lit on. An image sensor is provided in the receiver. The image sensor detects visible rays emitted from the light sources. The receiver converts brightness of the visible rays which is detected by the image sensor into a bit string to generate data.

However, in a conventional communication system, it is necessary to provide the expensive image sensor that can simultaneously detect the visible rays emitted from the plural light sources in order to ensure data reliability. Accordingly, in the conventional communication system, a cost of the receiver increases in order to improve the data reliability.

### BRIEF DESCRIPTION OF THE DRAWINGS

FIG. 1 is a block diagram of the communication system 1 of the first embodiment.

FIG. 2 is a configuration diagram illustrating an example of the emitting module 26 of the first embodiment.

FIG. 3 is a view illustrating an example of the receiver 10 of the first embodiment.

FIG. 4 is a flowchart illustrating the transmission operation of the first embodiment.

FIGS. 5A and 5B are schematic diagrams illustrating an example of the emission pattern in the transmission operation of the first embodiment.

FIG. 6 is a flowchart illustrating the reception operation of the first embodiment.

FIG. 7 is a schematic diagram illustrating the comparison table of the first embodiment.

FIG. 8A to 8D are schematic diagrams illustrating the emission pattern in the reception operation of the first embodiment.

FIG. 9 is a configuration diagram illustrating the emitting module 26 of the second embodiment.

FIGS. 10A and 10B are schematic diagrams illustrating an example of the issuing pattern in the transmission operation of the second embodiment.

FIG. 11 is a schematic diagram illustrating a comparison table of the second embodiment.

FIGS. 12A to 12D are schematic diagrams illustrating the emission pattern in the reception operation of the second embodiment.

### DETAILED DESCRIPTION

Embodiments will now be explained with reference to the accompanying drawings.

In general, according to one embodiment a receiver includes an image sensor, a synchronization controller, and a data generator. The image sensor detects a visible ray having a lattice-shaped emission pattern. The synchronization controller determines whether it is necessary to generate data based on a first synchronized visible ray located at a first lattice corner of the emission pattern and a second synchronized visible ray located at a second lattice corner. The second lattice corner is an opposite corner to the first lattice corner. The data generator generates the data corresponding to a data visible ray located at a lattice point other than the first lattice corner and the second lattice corner when the synchronization controller determines that it is necessary to generate the data.

### First Embodiment

A first embodiment will be described below. In the first embodiment, an example of a communication system that determines whether it is necessary to generate data based on brightness (for example, a value of a 256-level gray scale) of synchronized visible rays located at two lattice corners having a diagonal relationship in a lattice-shaped emission pattern will be described.

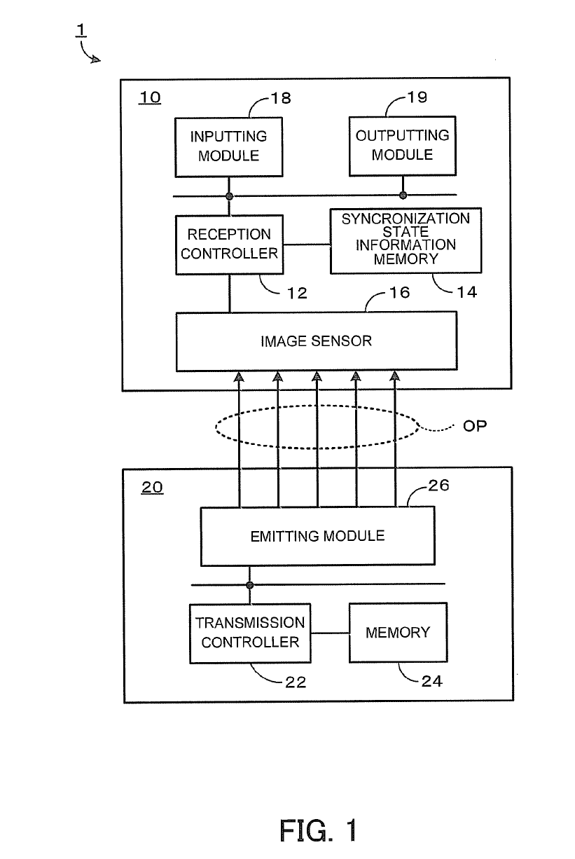

A configuration of a communication system 1 of the first embodiment will be described. FIG. 1 is a block diagram of the communication system 1 of the first embodiment. The communication system 1 includes a receiver 10 and a transmitter 20. The transmitter 20 includes a transmission controller 22, a memory 24, and an emitting module 26. For example, the transmitter 20 is a television set, a mobile phone, and a digital signage. The receiver 10 includes a reception controller 12, a synchronization state information memory 14, an image sensor 16, an inputting module 18, an outputting module 19. For example, the receiver 10 is the mobile phone. For example, the reception controller 12 and the transmission controller 22 are a processor.

The inputting module 18 receives an user instruction and provides the inputted user instruction to the reception controller 12. For example, the inputting module 18 is an inputting interface between an inputting device which issues an instruction for a reception operation and the receiver 10. For example, the inputting device is a keyboard or a switch. The outputting module 19 outputs data generated by the reception controller 12 to the outside of the receiver 10. For example, the outputting module 19 is an outputting interface between a storage medium, such as a memory and an HDD, and the receiver 10.

The transmitter 20 will be described. Various pieces of data are stored in the memory 24. The transmission controller 22 reads the data stored in the memory 24, and generates an emitting control signal according to an emission pattern corresponding to the read data to control the emitting module 26. The emitting module 26 emits a visible ray OP having an emission pattern corresponding to the emitting control signal.

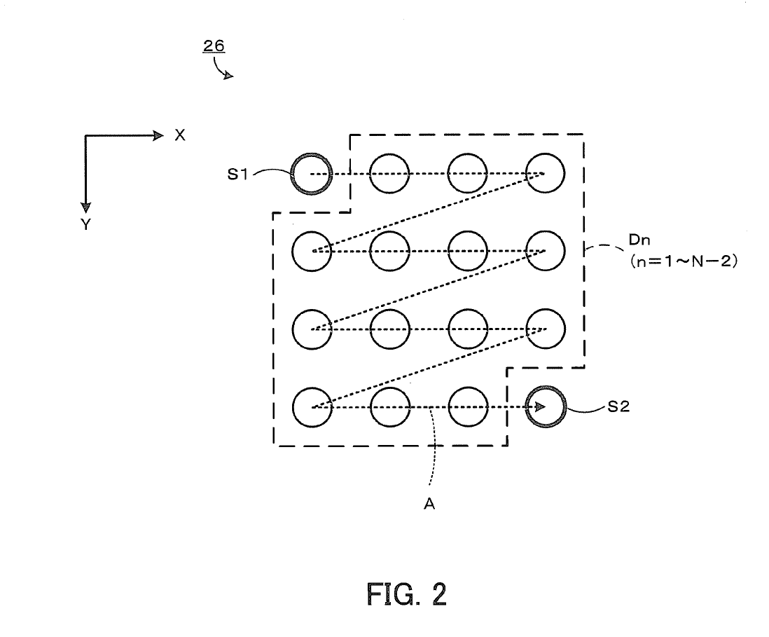

FIG. 2 is a configuration diagram illustrating an example of the emitting module 26 of the first embodiment. The emitting module 26 includes N (N is an integer of 3 or more) light sources. The N light sources include two synchronous light sources (first and second synchronous light sources S1 and S2) and a (N-2) data light source Dn (n=1 to N-2). FIG. 2 illustrates an example in which the light sources are arrayed into a 4-by-4 lattice shape (that is, at given intervals in an X and Y directions) when N=16.

The first and second synchronous light sources S1 and S2 are disposed at first and second lattice corners, respectively. In four corners of the lattice formed by the N light sources, the first lattice corner is located on a position in which the image sensor 16 initially detects the visible ray OP. The second lattice corner is located at an opposite corner to the first lattice corner, and located on a position in which the image sensor 16 finally detects the visible ray OP. The data light source Dn is a light source other than the synchronous light source in the N light sources.

The N light sources are lit on or turned off according to the emitting control signal. The first and second synchronous light sources S1 and S2 emit first and second synchronized visible rays, respectively during lit on. The data light source Dn emits a data visible ray during lit on. In the emission pattern of the visible ray OP, the first and second synchronized visible rays are located at the first and second lattice corners, respectively, and the data visible ray is located at a lattice point other than the first and second lattice corners.

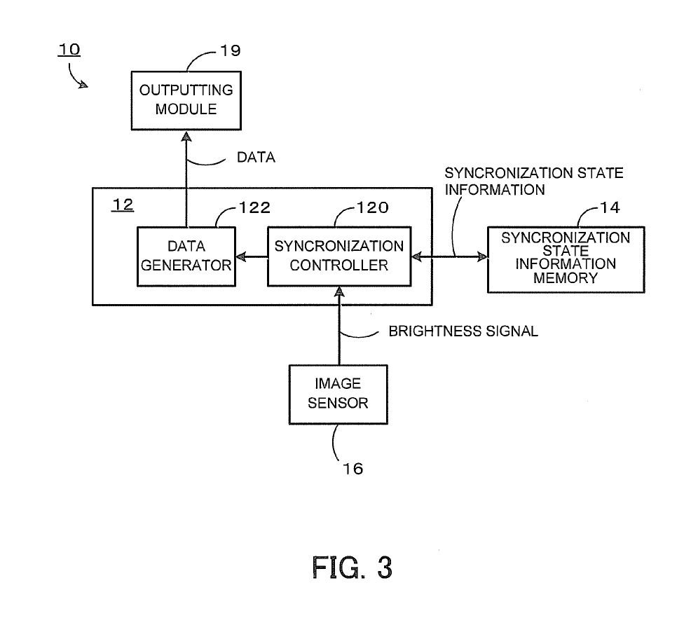

FIG. 3 is a view illustrating an example of the receiver 10 of the first embodiment. The image sensor 16 detects the visible, ray OP (the first and second synchronized visible rays and the data visible ray). For example, the image sensor 16 detects the visible ray OP having the lattice-shaped emission pattern in the order of an arrow A in FIG. 2. That is, the image sensor 16 initially detects the first synchronized visible ray emitted from the first synchronous light source S1, subsequently detects the data visible ray emitted from each of the data light sources Dn, and finally detects the second synchronized visible ray emitted from the second synchronous light source S2.

The reception controller 12 includes a synchronization controller 120 and a data generator 122. The synchronization controller 120 determines which it is a synchronization state or a non-synchronization state based on the brightness of the first and second synchronized visible rays, which is detected by the image sensor 16. In the synchronization state, synchronization state information indicating which it is a lights-on synchronization state or a lights-off synchronization state is written in the synchronization state information memory 14. The synchronization controller 120 determines whether it is necessary to generate the data based on the brightness of the first and second synchronized visible rays.

When the synchronization controller 120 determines that it is necessary to generate the data, the data generator 122 converts the brightness of the data visible rays into a bit string (1 or 0) to generate the data, and the data generator 122 supplies the generated data to the outputting module 19.

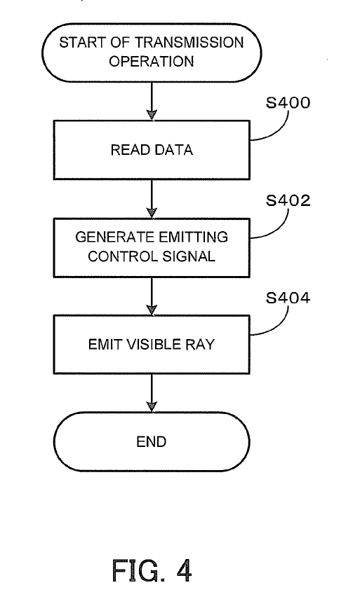

A transmission operation of the first embodiment will be described. FIG. 4 is a flowchart illustrating the transmission operation of the first embodiment. The transmission operation is performed by the transmitter 20. The transmission operation is started when a data transmission command is provided to the transmitter 20, and the transmission operation is performed plural times while the data to be transmitted is changed.

<S400 and S402> The transmission controller 22 reads the data to be transmitted from the pieces of data stored in the memory 24 (S400). Then the transmission controller 22 generates the emitting control signal to control the emitting module 26 according to the emission pattern corresponding to the read data (that is, the data to be transmitted) (S402).

In S402, when the data to be transmitted differs from the data already transmitted in the preceding transmission operation, the transmission controller 22 lights on a data light source OPd based on the data to be transmitted, and the transmission controller 22 generates the emitting control signal to control the first and second synchronous light sources S1 and S2 such that the first and second synchronized visible rays alternately repeat the lights-on synchronization state that is of a lights-on state and the lights-off synchronization state that is of a lights-off state. That is, the transmission controller 22 generates the emitting control signal such that a first synchronization state (for example, the lights-on synchronization state) in the emission patter corresponding to the already-transmitted data to a second synchronization state (for example, the lights-off synchronization state). Therefore, it can be ensured that the data to be transmitted differs from the already-transmitted data.

<S404> The emitting module 26 lights on or turns off the first and second synchronous light sources S1 and S2 and the data light source Dn so as to emit the visible ray OP having the emission pattern corresponding to the emitting control signal. Therefore, the visible ray OP having the emission pattern corresponding to the data to be transmitted can be obtained.

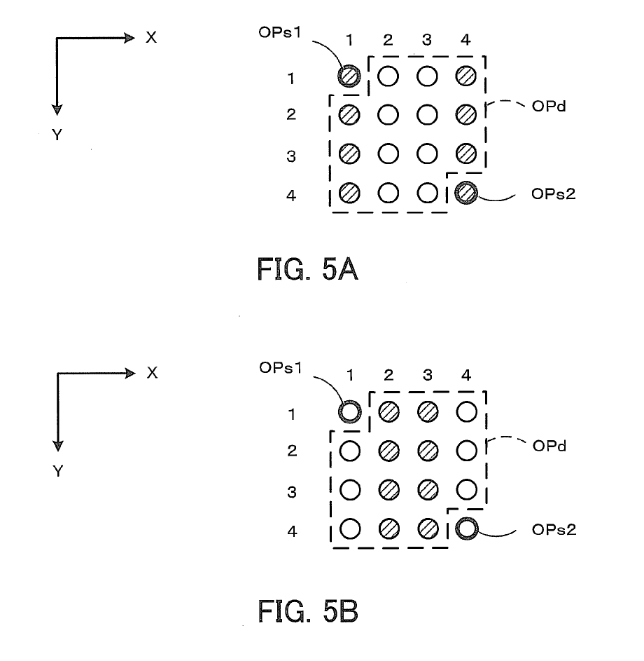

FIG. 5 is a schematic diagram illustrating an example of the emission pattern in the transmission operation of the first embodiment. For example, as illustrated in FIG. 5A, the transmission controller 22 generates the emitting control signal such that first and second synchronized visible rays OPs1 and OPs2 and data visible rays OPd12 to OPd14 and OPd41 to OPd43 are lit on. FIG. 5A illustrates the lights-on synchronization state.

When the data different from the already-transmitted data is transmitted in the lights-on synchronization state in FIG. 5A, the transmission controller 22 generates the emitting control signal such that the first and second synchronized visible rays OPs1 and OPs2 are in the lights-off state as illustrated in FIG. 5B. FIG. 5B illustrates the lights-off synchronization state. Moreover, the transmission controller 22 generates the emitting control signal to control the data visible ray OPd such that the data visible ray Opd corresponds to the data to be transmitted. In FIG. 5B, the data visible rays OPd21 to OPd24 and OPd31 to OPd34 are in the lights-on state.

Thus, when the different data (that is, the data necessary to be generated) is transmitted, the transmission controller 22 generates the emitting control signal such that the synchronization state is changed (that is, the lights-on synchronization state transits to the lights-off synchronization state, or the lights-off synchronization state transits to the lights-on synchronization state). Therefore, it can be ensured that the previously-transmitted data (for example, the data transmitted in the lights-on synchronization state) differs from the subsequently-transmitted (for example, the data transmitted in the lights-off synchronization state).

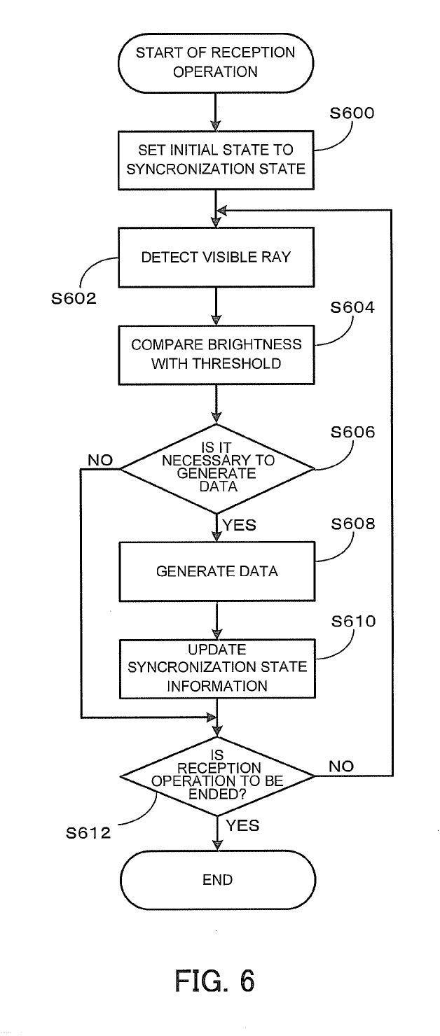

A reception operation of the first embodiment will be described. FIG. 6 is a flowchart illustrating the reception operation of the first embodiment. The reception operation is performed by the receiver 10. The reception operation is started when the image sensor 16 becomes possible to detect the visible ray OP (for example, when an angle formed between an emission surface of the emitting module 26 and a light reception surface of the image sensor 16 becomes a predetermined angle).

<S600 and S602> The synchronization state of the receiver 10 is set to an initial state. The synchronization controller 120 writes the synchronization state information indicating the initial state (the lights-off synchronization state or the lights-on synchronization state) in the synchronization state information memory 14 (S600). Then the image sensor 16 detects the visible ray OP emitted from the emitting module 26 (S602).

<S604 and S606> The synchronization controller 120 compares the brightness of the first and second synchronized visible rays with a predetermined threshold (S604), and the synchronization controller 120 determines whether it is necessary to generate the data based on a comparison table (S606). When determination that it is necessary to generate the data is made (YES in S606), the flow goes to S608. On the other hand, when determined that it is not necessary to generate the data is made (NO in S606), the flow goes to S612.

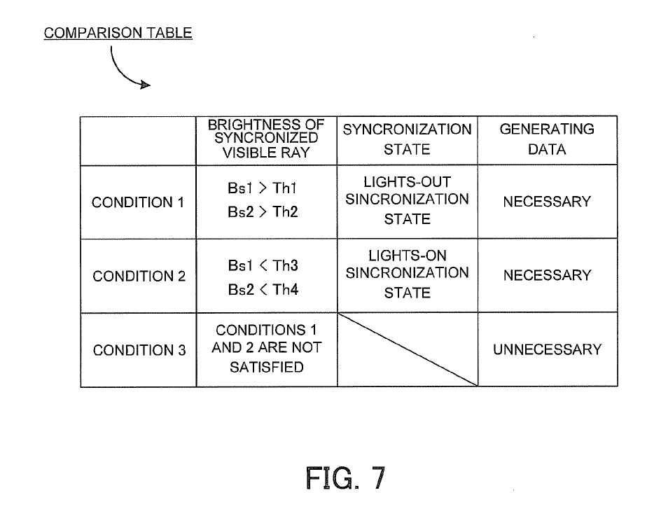

FIG. 7 is a schematic diagram illustrating the comparison table of the first embodiment. The synchronization controller 120 compares brightness Bs1 and Bs2 of the first and second synchronized visible rays with first and second thresholds Th1 and Th2 when the synchronization state information stored in the synchronization state information memory 14 indicates the lights-off synchronization state (that is, the synchronization state at the time point of S606 is the lights-off synchronization state), respectively. The synchronization controller 120 compares the brightness Bs1 and Bs2 of the first and second synchronized visible rays with third and fourth thresholds Th3 and Th4 when the synchronization state information stored in the synchronization state information memory 14 indicates the lights-on synchronization state (that is, the synchronization state at the time point of S606 is the lights-on synchronization state), respectively. The first to fourth thresholds Th1 to Th4 may be equal to one another or different from one another.

A condition 1 is satisfied when the brightness Bs1 and Bs2 of the first and second synchronized visible rays are larger than the first and second thresholds Th1 and Th2 in the lights-off synchronization state, respectively. The satisfaction of the condition 1 means that the lights-off synchronization state has transitioned to the lights-on synchronization state. In this case, the synchronization controller 120 determines that it is necessary to generate the data.

A condition 2 is satisfied when the brightness Bs1 and Bs2 of the first and second synchronized visible rays are smaller than the third and fourth thresholds Th3 and Th4 in the lights-on synchronization state, respectively. The satisfaction of the condition 2 means that the lights-on synchronization state has transitioned to the lights-off synchronization state. In this case, the synchronization controller 120 determines that it is necessary to generate the data.

A condition 3 is satisfied when the conditions 1 and 2 are not satisfied (that is, when the identical synchronization state is continued, or when only one of the first and second synchronous light sources S1 and S2 is lit on). The satisfaction of the condition 3 means the non-synchronization state. In this case, the synchronization controller 120 determines that it is not necessary to generate the data.

In other words, the satisfaction of the condition 1 or 2 means that the data corresponding to the data visible ray does not include an error (that is, the data reliability is ensured), and the un-satisfactions of conditions 1 and 2 mean that the data corresponding to the data visible ray includes the error (that is, the data reliability is not ensured). Accordingly, the synchronization controller 120 determines that it is necessary to generate the data when the condition 1 or 2 is satisfied, and the synchronization controller 120 determines that it is not necessary to generate the data when the conditions 1 and 2 are not satisfied.

<S608 and S610> The data generator 122 converts the brightness of the data visible rays into the bit string to generate the data (S608). Therefore, reliable data can be obtained. Then the synchronization controller 120 updates the synchronization state information (S610). In the synchronization state information, the lights-off synchronization state is rewritten to the lights-on synchronization state when the condition 1 is satisfied, and the lights-on synchronization state is rewritten to the lights-off synchronization state when the condition 2 is satisfied. The synchronization state information is not updated when the condition 3 is satisfied.

<S612> The synchronization controller 120 determines whether the reception operation is to be ended. When the reception operation is not to be ended (NO in S612), the flow returns to S602. On the other hand, when the reception operation is to be ended (YES in S612), the reception operation is ended. For example, the synchronization controller 120 determines that the reception operation is to be ended when the inputting module 18 receives an instruction to end the reception operation from a user, or when the visible ray OP is not detected for at least a given time.

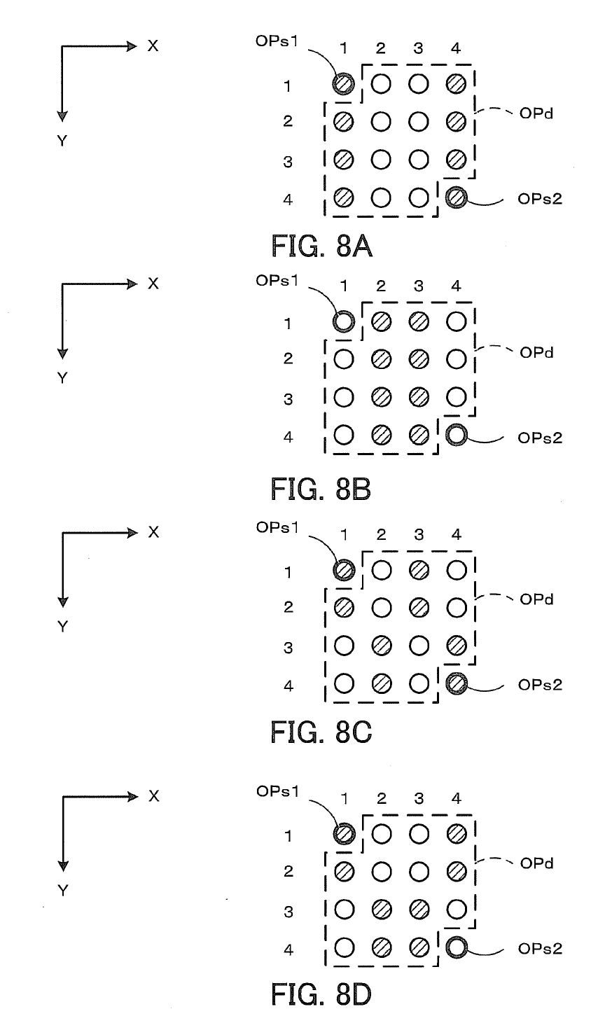

An example of the reception operation of the first embodiment will be described. FIG. 8 is a schematic diagram illustrating the emission pattern in the reception operation of the first embodiment. FIG. 8A illustrates the emission pattern of the visible ray OP, which is detected when the synchronization state information indicates the lights-off synchronization state. FIG. 8B to 8D illustrate the emission patterns of the visible ray OP, which are detected subsequent to that in FIG. 8A.

In FIG. 8A, because the first and second synchronized visible rays OPs1 and OPs2 are in the lights-on state, the lights-off synchronization state transits to the lights-on synchronization state. Accordingly, determination that it is necessary to generate the data is made, and the data corresponding to the emission pattern in FIG. 8A is thereby generated. As a result, the brightness of the data visible rays OPd12 to OPd14 and OPd41 to OPd43 in the lights-on state are converted into “1”, and the brightness of the data visible rays OPd21 to OPd24 and OPd31 to OPd34 in the lights-off state are converted into “0”.

In FIG. 8B, because the first and second synchronized visible rays OPs1 and OPs2 are in the lights-off state, the lights-on synchronization state transits to the lights-off synchronization state. Accordingly, determination that it is necessary to generate the data is made, and the data corresponding to the emission pattern in FIG. 8B (that is, the data different from the data corresponding to the emission pattern in FIG. 8A) is thereby generated. As a result, the brightness of the data visible rays OPd21 to OPd24 and OPd31 to OPd34 in the lights-on state are converted into “1”, and the brightness of the data visible rays OPd12 to OPd14 and OPd41 to OPd43 in the lights-off state are converted into “0”.

In FIG. 8C, the first and second synchronized visible rays OPs1 and OPs2 are in the lights-on state. In FIG. 8D, the first synchronized visible ray OPs1 is in the lights-on state, and the second synchronized visible ray OPs2 is in the lights-off state. Accordingly, there is the non-synchronization state in FIG. 8D. In this case, determination that it is not necessary to generate the data is made. That is, the data corresponding to the emission pattern in FIG. 8D is not generated.

According to the first embodiment, the image sensor 16 detects the visible ray having the lattice-shaped emission pattern. The synchronization controller 120 determines whether it is necessary to generate the data based on the brightness of the first synchronized visible ray located at the first lattice corner of the emission pattern and the brightness of the second synchronized visible ray located at the second lattice corner that is of the opposite corner to the first lattice corner. When the synchronization controller 120 determines that it is necessary to generate the data, the data generator 122 converts the brightness of the data visible rays located at the lattice points other than the first and the second lattice corners into the bit string to generate the data. In the configuration of the first embodiment, the inexpensive image sensor 16 can be used. Therefore, the data reliability can be improved, and the cost of the receiver 10 can be reduced.

### Second Embodiment

A second embodiment will be described below. In the second embodiment, a communication system that determines whether it is necessary to generate the data based on the brightness of synchronized visible rays located at four lattice corners in the lattice-shaped emission pattern will be described. The same description as the first embodiment is omitted.

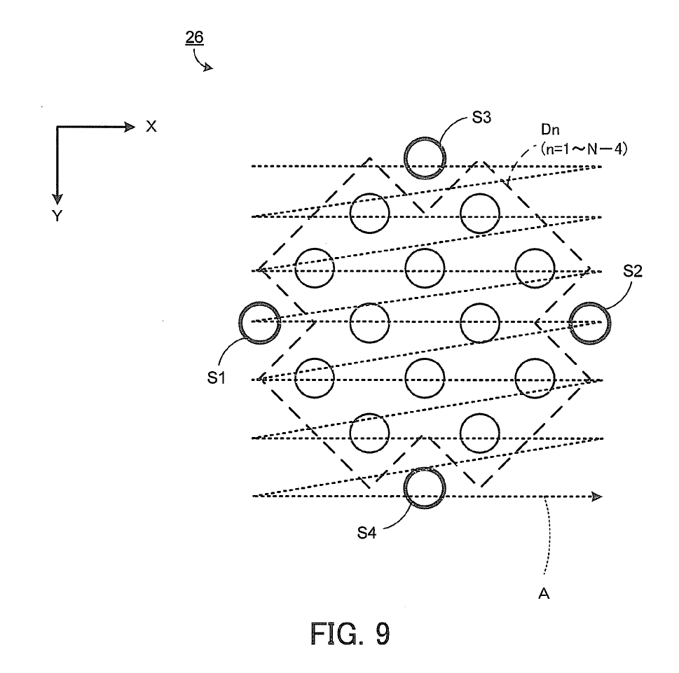

FIG. 9 is a configuration diagram illustrating the emitting module 26 of the second embodiment. The emitting module 26 includes N light sources that are arrayed into the lattice shaped (that is, at given intervals in the X and Y directions). In FIG. 9, N is set to 16. The N light sources include four synchronous light sources (first to fourth synchronous light sources S1 to S4) and (N-4) data light sources Dn (n=1 to N-4).

The first to fourth synchronous light sources S1 to S4 are disposed at first to fourth lattice corners, respectively. The first and second lattice corners are identical to those of the first embodiment. The third and fourth lattice corners are two corners other than the first and second lattice corners in the four corners formed by the N light sources. That is, the third lattice corner is located at the opposite corner to the fourth lattice corner. The data light source Dn is a light source other than the synchronous light source in the N light sources.

The N light sources are lit on or turned off according to the emitting control signal. The first to fourth synchronous light sources S1 to S4 emit first to fourth synchronized visible rays, respectively, while the light sources are lit on. The data light source Dn emits the data visible ray while the light sources are lit on. In the emission pattern of the visible ray OP, the first to fourth synchronized visible rays are located at the first to fourth lattice corners, respectively, and the data visible ray is located at the lattice point other than the first to fourth lattice corners.

The image sensor 16 detects the visible ray OP (the first to fourth synchronized visible rays and the data visible ray). For example, as illustrated in FIG. 9, the image sensor 16 detects the visible ray OP in the order of the arrow A when the lattice-shaped emission pattern is obliquely disposed. That is, the image sensor 16 detects the synchronized visible rays in the order of the third synchronized visible ray, the first synchronized visible ray, the second synchronized visible ray, and the fourth synchronized visible ray.

The initially-detected synchronized visible ray varies according to the angle formed between the emission surface of the emitting module 26 and the light reception surface of the image sensor 16. However, because the first to fourth synchronous light sources S1 to S4 are located at the four lattice corners, one of the first to fourth synchronized visible rays is initially detected, and the synchronized visible ray located at the opposite corner to the initially-detected synchronized visible ray is finally detected. For example, the fourth synchronized visible ray is finally detected when the third synchronized visible ray is initially detected.

The transmission operation of the second embodiment will be described. A flowchart of the transmission operation of the second embodiment is identical to that (see FIG. 4) of the transmission operation of the first embodiment. The transmission operation of the second embodiment is performed by the transmitter 20. The transmission operation is started when the data transmission command is provided to the transmitter 20.

In S402, when the data to be transmitted differs from the data already transmitted in the preceding transmission operation, the transmission controller 22 lights on the data visible ray light source OPd based on the data to be transmitted, and the transmission controller 22 generates the emitting control signal such that the first to fourth synchronized visible rays alternately repeat the lights-on synchronization state and the lights-off synchronization state. That is, the transmission controller 22 generates the emitting control signal such that synchronization state (for example, the lights-on synchronization state) in the emission pattern corresponding to the already-transmitted data to another synchronization state (for example, the lights-off synchronization state). Therefore, it can be ensured that the data to be transmitted is un-transmitted.

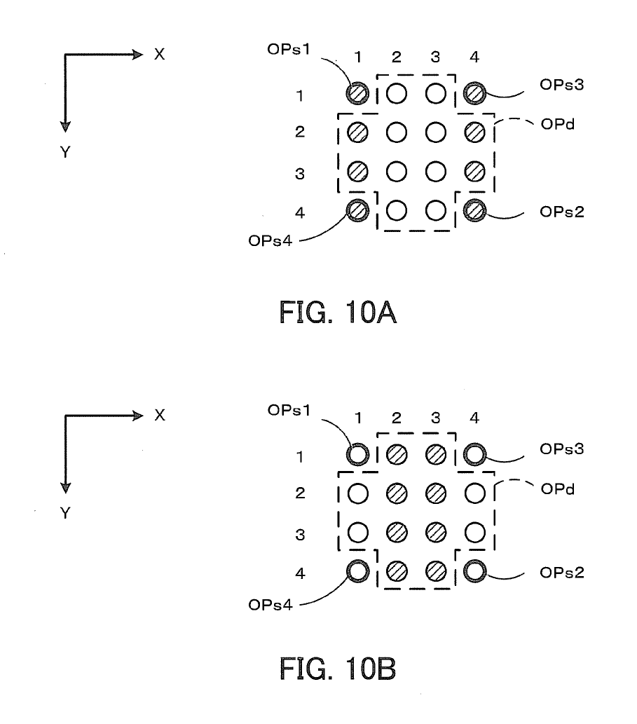

FIG. 10 is a schematic diagram illustrating an example of the issuing pattern in the transmission operation of the second embodiment. For example, as illustrated in FIG. 10A, the transmission controller 22 generates the emitting control signal such that the first to fourth synchronized visible rays OPs1 to OPs4 and the data visible rays OPd12, OPd13, O0Pd42, and OPd43 are lit on. FIG. 10A illustrates the lights-on synchronization state.

When the data different from the already-transmitted data is transmitted in the lights-on synchronization state in FIG. 10A, the transmission controller 22 generates the emitting control signal such that an arbitrary data visible ray OPd is in the lights-on state, and such that the first to fourth synchronized visible rays OPs1 to OPs4 are in the lights-off state. FIG. 10B illustrates the lights-off synchronization state.

The reception operation of the second embodiment will be described. The reception operation of the second embodiment is performed by the receiver 10 in the same sequence as that of the first embodiment (see FIG. 6). The reception operation is started when the image sensor 16 becomes ready to detect the visible ray OP (for example, when the first to fourth synchronized visible rays enter a detection range of the image sensor 16).

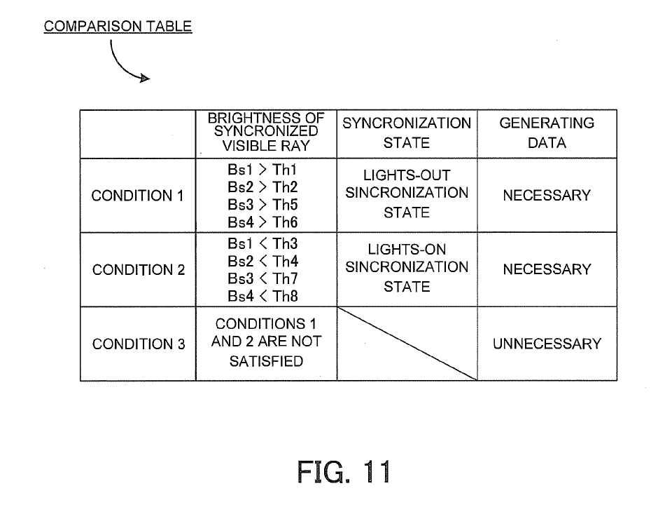

FIG. 11 is a schematic diagram illustrating a comparison table of the second embodiment. When the synchronization state information indicates the lights-off synchronization state, the synchronization controller 120 compares brightness Bs1 to Bs4 of the first to fourth synchronized visible rays with first, second, fifth, and sixth thresholds Th1, Th2, Th5, and Th6, respectively. When the synchronization state information indicates the lights-on synchronization state, the synchronization controller 120 compares the brightness Bs1 to Bs4 of the first to fourth synchronized visible rays with third, fourth, seventh, and eighth thresholds Th3, Th4, Th7, and Th8, respectivley. The first to eighth thresholds Th1 to Th8 may be identical to one another, or different from one another.

The condition 1 is satisfied when the brightness Bs1 to Bs4 of the first to fourth synchronized visible rays are larger than the first, second, fifth, and sixth thresholds Th1, Th2, Th5, and Th6 in the lights-off synchronization state, respectively. The satisfaction of the condition 1 means that the lights-off synchronization state has transitioned to the lights-on synchronization state. In this case, the determination that it is necessary to generate the data is made.

The condition 2 is satisfied when the brightness Bs1 to Bs4 of the first to fourth synchronized visible rays are smaller than the third, fourth, seventh, and eighth thresholds Th3, Th4, Th7, and Th8, respectively. The satisfaction of the condition 2 means that the lights-on synchronization state has transitioned to the lights-off synchronization state. In this case, the determination that it is necessary to generate the data is made.

The condition 3 is satisfied when the conditions 1 and 2 are not satisfied (that is, when the identical synchronization state is continued, or when the lights-on state and the lights-off states of the first to fourth synchronized visible rays are mixed together). The satisfaction of the condition 3 means the non-synchronization state. In this case, the determination that it is not necessary to generate the data is made.

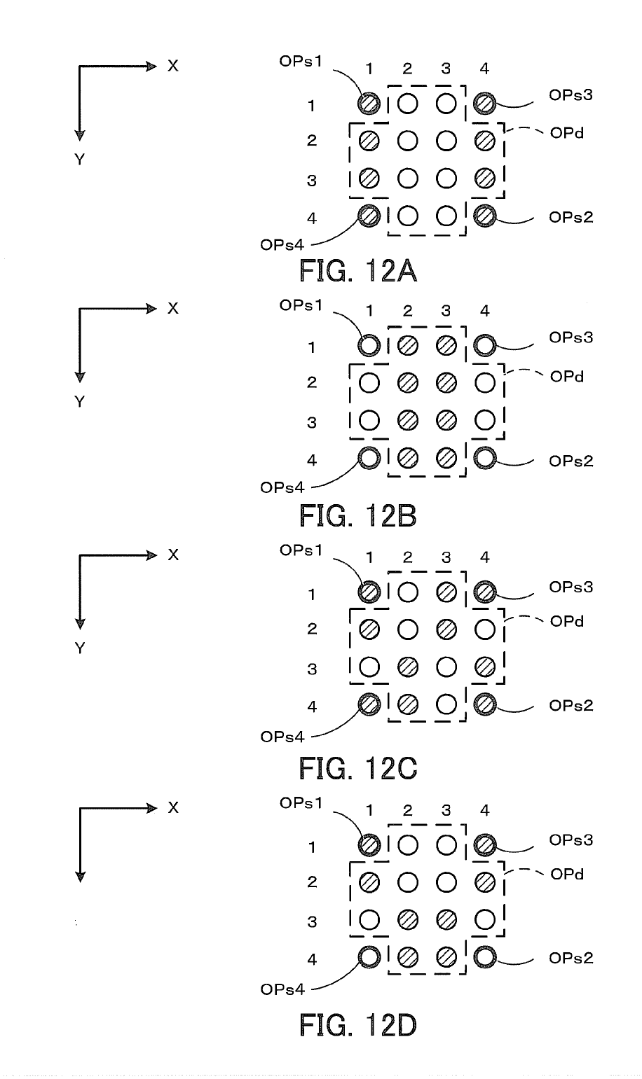

An example of the reception operation of the second embodiment will be described. FIG. 12 is a schematic diagram illustrating the emission pattern in the reception operation of the second embodiment. FIG. 12A illustrates the emission pattern of the visible ray OP, which is detected when the synchronization state information indicates the lights-off synchronization state. FIG. 12B to 12D illustrate the emission patterns of the visible ray OP, which are detected subsequent to that in FIG. 12A.

In FIG. 12A, because the first to fourth synchronized visible rays OPs1 to OPs4 are in the lights-on state, the lights-off synchronization state transits to the lights-on synchronization state. Accordingly, the determination that it is necessary to generate the data is made, and the data corresponding to the emission pattern in FIG. 12A is thereby generated. As a result, the brightness of the data visible rays OPd12, OPd13, OPd42, and OPd43 in the lights-on state are converted into “1”, and the brightness of the data visible rays OPd21 to OPd24 and OPd31 to OPd34 in the lights-off state are converted into “0”.

In FIG. 12B, because the first to fourth synchronized visible rays OPs1 to OPs4 are in the lights-off state, the lights-on synchronization state transits to the lights-off synchronization state. Accordingly, the determination that it is necessary to generate the data is made, and the data corresponding to the emission pattern in FIG. 12B (that is, the data different from the data corresponding to the emission pattern in FIG. 12A) is thereby generated. As a result, the brightness of the data visible rays OPd21 to OPd24 and OPd31 to OPd34 in the lights-on state are converted into “1”, and the brightness of the data visible rays OPd12, OPd13, OPd42, and OPd43 in the lights-off state are converted into “0”.

In FIG. 12C, because the first to fourth synchronized visible rays OPs1 to OPs4 are in the lights-on state, the lights-off synchronization state transits to the lights-on synchronization state. Accordingly, the determination that it is necessary to generate the data is made. In FIG. 12D, the first and third synchronized visible rays OPs1 and OPs3 are in the lights-on state, and the second and fourth synchronized visible rays OPs2 and OPs4 are in the lights-off state. Accordingly, there is the non-synchronization state in FIG. 12D. In this case, the determination that it is not necessary to generate the data is made. That is, the data corresponding to the emission pattern in FIG. 12D is not generated.

According to the second embodiment, whether it is necessary to generate the data is determined based on the brightness of the first to fourth synchronized visible rays located at the first to fourth lattice corners in the lattice-shaped emission pattern. Therefore, the data reliability can be improved irrespective of the angle formed between the emission surface of the emitting module 26 and the light reception surface of the image sensor 16.

Additionally, according to the second embodiment, it is not necessary for a user to make aware of the angle formed between the emission surface of the image sensor 16 and the emitting module 26, so that usability can be improved compared with the first embodiment.

Incidentally, the case that the brightness of the synchronized visible ray is equal to the threshold is not specifically described in the first and second embodiments. However, in the case that the brightness of the synchronized visible ray is equal to the threshold, the determination that the conditions 1 and 2 are satisfied (that is, it is necessary to generate the data) may be made, or the determination that the conditions 1 and 2 are not satisfied (that is, it is not necessary to generate the data) may be made.

In the first and second embodiments, the emitting module having plural light sources which are arrayed into lattice-shaped is described by way of example. Alternatively, the data may be generated based on the detection of the emission pattern of the issuing module having a linear arrangement to determine the lights-on synchronization states or the lights-off synchronization states of the synchronous light sources located at both ends (corresponds to the first and second lattice corners). In the first and second embodiments, whether it is necessary to generate the data is determined using the brightness of the visible ray by way of example. However, when a color image of the emission pattern can be acquired, the determination may be made based on hue, saturation, and the brightness of each color signal.

At least a portion of the communication system 1 according to the above-described embodiments may be composed of hardware or software. When at least a portion of the communication system 1 is composed of software, a program for executing at least some functions of the communication system 1 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the communication system 1 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A receiver comprising:
an image sensor configured to detect a visible ray having a lattice-shaped emission pattern;
a synchronization controller configured to determine whether it is necessary to generate data based on a first synchronized visible ray located at a first lattice corner of the emission pattern and a second synchronized visible ray located at a second lattice corner, the second lattice corner being an opposite corner to the first lattice corner; and
a data generator configured to generate the data corresponding to a data visible ray located at a lattice point other than the first lattice corner and the second lattice corner when the synchronization controller determines that it is necessary to generate the data.

2. The receiver of claim 1, wherein the synchronization controller determines that it is necessary to generate the data when first brightness of the first synchronized visible ray and second brightness of the second synchronized visible ray are in a synchronization state.

3. The receiver of claim 1, wherein the synchronization controller determines that it is necessary to generate the data when a lights-on synchronization state in which first brightness of the first synchronized visible ray and second brightness of the second synchronized visible ray are larger than a threshold transits to a lights-off synchronization state in which the first brightness and the second brightness are smaller than the threshold, or when the lights-off synchronization state transits to the lights-on synchronization state.

4. The receiver of claim 3, wherein the synchronization controller determines that it is necessary to generate the data when the first brightness is larger than a first threshold while the second brightness is larger than a second threshold in the lights-off synchronization state.

5. The receiver of claim 3, wherein the synchronization controller determines that it is necessary to generate the data when the first brightness is smaller than a third threshold while the second brightness is smaller than a fourth threshold in the lights-on synchronization state.

6. The receiver of claim 3, further comprising a synchronization state information memory in which synchronization state information is stored, the synchronization state information indicating the synchronization state corresponding to the first brightness and the second brightness,
wherein, in the case that the synchronization state information indicates the lights-on synchronization state, the synchronization controller rewrites the synchronization state information to information indicating the lights-off synchronization state when determining that it is necessary to generate the data, and
in the case that the synchronization state information indicates the lights-off synchronization state, the synchronization controller rewrites the synchronization state information to information indicating the lights-on synchronization state when determining that it is necessary to generate the data.

7. The receiver of claim 1, wherein the image sensor detects the visible ray of the emission pattern in a raster-scan order.

8. The receiver of claim 7, wherein the synchronization controller determines whether it is necessary to generate the data based on first brightness of the first synchronized visible ray initially detected in the raster-scan order and second brightness of the second synchronized visible ray finally detected in the raster-scan order in the synchronized visible rays located at four corners of the emission pattern.

9. The receiver of claim 1, wherein the synchronization controller determines whether it is necessary to generate the data based on first brightness of the first synchronized visible ray, second brightness of the second synchronized visible ray, third brightness of a third synchronized visible ray located at a third lattice corner, and fourth brightness of a fourth synchronized visible ray located at a fourth lattice corner that is of the opposite corner to the third lattice corner.

10. The receiver of claim 9, wherein the synchronization controller determines that it is necessary to generate the data when a lights-on synchronization state in which the first brightness to the fourth brightness are larger than a threshold transits to a lights-off synchronization state in which the first brightness to the fourth brightness are less than the threshold, or when the lights-off synchronization state transits to the lights-on synchronization state.

11. The receiver of claim 10, wherein the synchronization controller determines that it is necessary to generate the data when the first brightness is larger than a first threshold, the second brightness is larger than a second threshold, the third brightness is larger than a fifth threshold, and the second brightness is larger than a sixth threshold, in the lights-off synchronization state.

12. The receiver of claim 10, wherein the synchronization controller determines that it is necessary to generate the data when the first brightness is smaller than a third threshold, the second brightness is smaller than a fourth threshold, the third brightness is smaller than a seventh threshold, and the fourth brightness is smaller than a eighth threshold, in the lights-on synchronization state.

13. The receiver of claim 10, further comprising a synchronization state information memory in which synchronization state information is stored, the synchronization state information indicating the synchronization state corresponding to the first brightness to the fourth brightness,
wherein, in the case that the synchronization state information indicates the lights-on synchronization state, the synchronization controller rewrites the synchronization state information to information indicating the lights-off synchronization state when determining that it is necessary to generate the data, and
in the case that the synchronization state information indicates the lights-off synchronization state, the synchronization controller rewrites the synchronization state information to information indicating the lights-on synchronization state when determining that it is necessary to generate the data.

14. A transmitter comprising a plurality of light sources disposed into a lattice shape, the transmitter comprising:
a first synchronous light source disposed at a first lattice corner and configured to emit a first synchronized visible ray;
a second synchronous light source disposed at a second lattice corner and configured to emit a second synchronized visible ray, the second lattice corner being an opposite corner to the first lattice corner;
a data light source disposed at a lattice point other than the first lattice corner and the second lattice corner and configured to emit a data visible ray; and
a transmission controller configured to control the data light source based on data to be transmitted, and generate an emitting control signal to control the first synchronous light source and the second synchronous light source in such a manner that a lights-on synchronization state in which the first synchronized visible ray and the second synchronized visible ray are in a lights-on state and a lights-off synchronization state in which the first synchronized visible ray and the second synchronized visible ray are in a lights-off state are alternately repeated,
wherein the first synchronous light source, the second synchronous light source, and the data light source are lit on or turned off so as to emit visible rays having an emission pattern corresponding to the emitting control signal.

15. The transmitter according to claim 14, further comprising:
a third synchronous light source disposed at a third lattice corner and configured to emit a third synchronized visible ray; and
a fourth synchronous light source located at fourth lattice corner and configured to emit a fourth synchronized visible ray, the fourth lattice corner being the opposite corner to the third lattice corner,
wherein the transmission controller generates an emitting control signal to control the first synchronous light source to the fourth synchronous light source in such a manner that a lights-on synchronization state in which the first synchronized visible ray to the fourth synchronized visible ray are in the lights-on state and a lights-off synchronization state in which
the first synchronized visible ray to the fourth synchronized visible ray are in the lights-off state are alternately repeated, and the first synchronous light source to the fourth synchronous light source and the data light source are lit on or turned off so as to emit visible rays having an emission pattern corresponding to the emitting control signal.

16. A communication system comprising a transmitter configured to transmits data corresponding to a visible ray having a lattice-shaped emission pattern and a receiver configured to receive the data,
wherein the transmitter comprises:
a plurality of light sources comprising a first synchronous light source, a second synchronous light source, and a data light source, the first synchronous light source disposed at a first lattice corner and configured to emit a first synchronized visible ray, the second synchronous light source disposed at a second lattice corner and configured to emit a second synchronized visible ray, the second lattice corner being an opposite corner to the first lattice corner, and the data light source disposed at a lattice point other than the first lattice corner and the second lattice corner and configured to emit a data visible ray; and
a transmission controller configured to control the data light source based on data to be transmitted, and generate an emitting control signal to control the first synchronous light source and the second synchronous light source in such a manner that a lights-on synchronization state in which the first synchronized visible ray and the second synchronized visible ray are in a lights-on state and a lights-off synchronization state in which the first synchronized visible ray and the second synchronized visible ray are in a lights-off state are alternately repeated,
wherein the light sources are lit on or turned off so as to emit visible rays having an emission pattern corresponding to the emitting control signal,
the receiver comprises:
an image sensor configured to detect the first synchronized visible ray, the second synchronized visible ray, and the data visible ray;
a synchronization controller configured to determine whether it is necessary to generate the data based on the first synchronized visible ray and the second synchronized visible ray; and
a data generator configured to generate the data corresponding to the data visible ray when the synchronization controller determines that it is necessary to generate the data.

17. The system of claim 16, wherein the synchronization controller determines that it is necessary to generate the data when a lights-on synchronization state in which first brightness of the first synchronized visible ray and second brightness of the second synchronized visible ray are larger than a threshold transits to a lights-off synchronization state in which the first brightness and the second brightness are smaller than the threshold, or when the lights-off synchronization state transits to the lights-on synchronization state.

18. The system of claim 17, wherein the synchronization controller determines that it is necessary to generate the data when the first brightness is larger than a first threshold while the second brightness is larger than a second threshold in the lights-off synchronization state.

19. The system of claim 17, wherein the synchronization controller determines that it is necessary to generate the data when the first brightness is smaller than a third threshold while the second brightness is smaller than a fourth threshold in the lights-on synchronization state.

20. The system of claim 16, wherein the transmitter further comprises:
a third synchronous light source disposed at a third lattice corner and configured to emit a third synchronized visible ray; and
a fourth synchronous light source located at fourth lattice corner and configured to emit a fourth synchronized visible ray, the fourth lattice corner being the opposite corner to the third lattice corner,
wherein the receiver determines that it is necessary to generate the data based on the first brightness, the second brightness, third brightness of the third synchronized visible ray, and fourth brightness of the fourth synchronized visible ray.
